(19) United States
(12) Patent Application Publication
(10) Pub. No.: US 2024/0173846 A1
(43) Pub. Date: May 30, 2024

(54) DEVICE FOR HUMAN UPPER ARM ASSISTANCE

(71) Applicant: NATIONAL UNIVERSITY OF SINGAPORE, Singapore (SG)

(72) Inventors: Shuo DING, Singapore (SG); Haoyong YU, Singapore (SG)

(73) Assignee: NATIONAL UNIVERSITY OF SINGAPORE, Singapore (SG)

(21) Appl. No.: 18/285,121

(22) PCT Filed: Apr. 5, 2022
(86) PCT No.: PCT/SG2022/050191

§ 371 Date: Sep. 29, 2023

(30) Foreign Application Priority Data
Apr. 5, 2021 (SG) 10202103469S
Oct. 19, 2021 (CN) 202111216898.2

(51) Int. Cl. B25J 9/00; A61H 1/02

(52) U.S. Cl. CPC B25J 9/0006; A61H 1/0281; A61H 2201/1215; A61H 2201/1238; A61H 2201/1621; A61H 2201/5061; A61H 2201/5069; A61H 2201/5079

(57) ABSTRACT

The present disclosure provides a device for assisting an upper arm of a user, which includes: a support mechanism configured for supporting the device on a torso of the user; an arm link member connectable to the upper arm: a joint member coupled with the arm link member and the support mechanism, and a force generating member arranged on the support mechanism. The device, in use, transfers a load from the upper arm, through the joint member to the torso. The force generating member is configured for providing a resisting torque between the arm link member and support mechanism, and the force generating member is mechanically configured to apply a relatively larger resisting torque at a predetermined range of motion of the upper arm and to apply a relatively lesser resisting torque outside the predetermined range.

### TECHNICAL FIELD

The present disclosure relates to devices that assist human arm(s), more particularly to a portable device for human upper arm assistance that is worn by a user and reduces moment on a shoulder joint of the user during arm outstretching or overhead tasks performance. The device can be applicable in many scenarios such as factories, warehouses, hospital, construction, daily life assist and so on.

### BACKGROUND

The statements herein only provide background information related to the present disclosure, and do not necessarily constitute prior art. Shoulder injury is the second frequent work-related musculoskeletal disorders (WMSDs) and it takes a long time to recover. In many tasks, such as wall painting, product assembly, glass cleaning, patient care, house renovation and so on, workers need to frequently outstretch their arms to lift or hold tools overhead and muscle fatigues are caused by resisting the gravity of the tools and the arms for a long time. To protect the workers from the shoulder injury and reduce the economic losses, a device for human upper arm assistance that can provide assist torque to the shoulder joint and relieve the muscle fatigues is urgently needed.

The device for human upper arm assistance may be divided into two types, i.e., the passive type and the active type. The passive type devices provide assist by a rebound force of a spring or an elastic rope that is compressed or stretched. However, one of main drawbacks of passive type is that the assistive forces can't be adaptive according to the load the user is handling. Another drawback of the passive type is that, in non-working conditions, human cannot move freely because of the resistance from the spring or elastic rope, thus feels uncomfortable. The active type devices can solve these problems by actively following human's motion in non-working conditions. But, current active type devices, directly place the actuator at human's shoulder position and align the motor axis to human's shoulder joint axis, causing a bulky and heavy frame at shoulder and wasting a lot of energy at the same time since the actuator should move by the human in the non-assist directions. Another important requirement for arm assisting devices is that the torque applied at the shoulder joint should be automatically reduced when the arm is near the natural drooping position. However, the devices always apply torque between arm and torso, which makes the user feel uncomfortable in daily activities such as walking, standing, siting and so on.

### SUMMARY

The various embodiments described herein are directed to a device for human upper arm assistance, on the one hand, it provides torque between upper arm and torso for supporting the arm during arm outstretching or overhead tasks performance thereby reducing the muscle fatigue of the shoulder joint, one the other hand, the torque applied at the shoulder joint can be automatically reduced when the arm is near the natural drooping position thereby saving energy and let the user feel free in daily activities.

In accordance with an aspect of the present disclosure, it is provided a device for assisting an upper arm of a user, including: a support mechanism, an arm link member, a joint member, and a force generating member. The support mechanism is configured for supporting the device on a torso of the user. The arm link member is connectable to the upper arm. The joint member is coupled with the arm link member and the support mechanism, where the device, in use, transfers a load from the upper arm, through the joint member to the torso. The force generating member is arranged on the support mechanism and is configured for providing a resisting torque between the arm link member and support mechanism, where the force generating member is mechanically configured to apply a relatively larger resisting torque at a predetermined range of motion of the upper arm and to apply a relatively lesser resisting torque outside the predetermined range.

In one embodiment, the predetermined range of the motion of the upper arm includes a case where the upper arm is perpendicular to the torso.

In one embodiment, the force generating member is configured to provide largest resisting torque when the upper arm is raised perpendicular to the torso.

In one embodiment, the force generating member is configured to apply substantially no force when the upper arm is in a natural drooping position.

In one embodiment, the joint member is rotatably coupled to the arm link member and the support mechanism, and is arranged parallel to a shoulder joint of the user when the device is in a mounted state.

In one embodiment, the force generating member is a torque generator which includes an eccentric pulley, where the eccentric pulley moves, in use, with the upper arm, and an eccentricity of the eccentric pulley defines the predetermined range.

In one embodiment, the force generating member includes one or more springs for controlling a magnitude of the resisting torque.

In one embodiment, the force generating member is a force generator which includes a hydraulic cylinder, an electric motor or a pneumatic system for generating a resisting torque.

In one embodiment, the force generating member is configured to apply the resisting torque at the joint member using one or more Bowden cables.

In one embodiment, the device further includes: a sensor system configured to detect information of the user; and a control module configured to generate and provide a control signal to the force generator based on the information of the user detected by the sensor system.

In one embodiment, the sensor system is in communication with the control module to control at least one aspect of toggling the force generator between a working mode in which the force generator generates a resisting torque and a non-working mode in which the force generator does not generate a resisting torque.

In one embodiment, the sensor system includes one or more of an angle sensor, a velocity sensor, a force sensor and an accelerometer.

In one embodiment, a length of the arm link member is adjustable.

In one embodiment, the support mechanism is mounted on a back of the user by a back strap, and elastic ropes are provided connecting the back strap and the support mechanism.

In accordance with another aspect of the present disclosure, it is provided a device for assisting at least one upper arm of a user, including: a support mechanism, two support link members, two arm link members, two joint members, and at least one force generating member. The support mechanism is configured for supporting the device on a torso of the user, and the support mechanism is provided with a base bracket, and two support link members respectively coupled to the base bracket. The two arm link members is connectable to the upper arm. The two joint members is coupled with the two arm link members and the two support link members, respectively, where the device, in use, transfers a load from the upper arm, through the two joint members to the torso. The at least one force generating member is arranged on the base bracket and configured for providing a resisting torque between each arm link member and the support mechanism, where the at least one force generating member is mechanically configured to apply a relatively larger resisting torque at a predetermined range of motion of the upper arm and to apply a relatively lesser resisting torque outside the predetermined range.

In one embodiment, the predetermined range of the motion of the upper arm includes a case where the upper arm is perpendicular to the torso.

In one embodiment, the at least one force generating member is configured to provide largest resisting torque when the upper arm is raised perpendicular to the torso.

In one embodiment, the at least one force generating member is configured to apply substantially no force when the upper arm is in a natural drooping position.

In one embodiment, the joint member is rotatably coupled with the arm link member and the support mechanism, and is arranged parallel to a shoulder joint of the user when the device is in a mounted state.

In one embodiment, each of the at least one force generating member is a torque generator which includes an eccentric pulley, wherein the eccentric pulley moves, in use, with the upper arm, and an eccentricity of the eccentric pulley defines the predetermined range.

In one embodiment, each of the at least one force generating member includes one or more springs for controlling a magnitude of the resisting torque.

In one embodiment, each of the at least one force generating member is a force generator which includes a hydraulic cylinder, an electric motor or a pneumatic system for generating a resisting torque.

In one embodiment, the at least one force generating member is configured to apply the resisting torque at the joint member using one or more Bowden cables.

In one embodiment, the device for assisting at least one upper arm of a user further includes: a sensor system configured to detect information of the user; and a control module configured to generate and provide a control signal to the at least one force generator based on the information of the user detected by the sensor system.

In one embodiment, the sensor system is in communication with the control module to control at least one aspect of toggling the at least one force generator between a working mode in which the force generator generates a resisting torque and a non-working mode in which the force generator does not generate a resisting torque.

In one embodiment, the sensor system includes one or more of an angle sensor, a velocity sensor, a force sensor and an accelerometer.

In one embodiment, the support mechanism is configured to support the device through the base bracket, and the base bracket is attached to a back of the user by a back strap during operation.

In one embodiment, each support link member is coupled to the base bracket through a universal bearing.

In one embodiment, a length of each support link member is adjustable and/or a length of each arm link member is adjustable.

In one embodiment, the device further includes elastic ropes connected between the back strap and the two support link members.

In accordance with another aspect of the present disclosure, it is provided a device for assisting at least one upper arm of a user, which includes: at least one arm link member, a base bracket, at least one support link member, at least one joint member, and at least one force generating member. The at least one arm link member is connectable to the upper arm of the user. The base bracket is attachable to a torso of the user. The at least one support link member is coupled to the base bracket. The at least one joint member is rotatably coupled with the at least one arm link member and the at least one support link member, respectively, where the device, in use, transfers load from the upper arm, through the at least one joint member to the torso of the user. The at least one force generating member arranged on the base bracket and configured to provide a resisting torque between the at least one arm link member and the at least one support link member, respectively. Where the at least one force generating member is mechanically configured to apply a relatively larger resisting torque at a predetermined range of motion of the upper arm and to apply a relatively lesser resisting torque outside the predetermined range. Where the at least one force generating member is configured to provide largest resisting torque when the upper arm is raised perpendicular to the torso, and provide substantially no torque when the upper arm is in a natural drooping position.

### BRIEF DESCRIPTION OF THE DRAWINGS

These and other aspects, features and advantages of the present disclosure will become more readily appreciated when considered in connection with the following detailed description of various embodiments and accompanying drawings, in the figures of the accompanying drawings in which like reference numerals refer to similar elements, in which:

FIG. 1 shows a perspective view of a user wearing an exemplary device for human upper arm assistance, with user's one arm outstretched, in accordance with the present disclosure;

FIG. 2 shows a perspective view of a user wearing the device for human upper arm assistance, with user's two arms outstretched for overhead working, in accordance with the present disclosure;

FIG. 3 shows a perspective view of a user wearing the device for human upper arm assistance, with user's two hands reaching same position for overhead operating, in accordance with the present disclosure;

FIG. 4 shows a perspective view of a user wearing the device for human upper arm assistance, with user's two arms extend horizontally, in accordance with the present disclosure;

FIG. 5 shows a perspective view of the device for upper arm assistance, where elastic ropes are attached between a back strap and a support link, in accordance with the present disclosure;

FIG. 6 shows a close-up perspective view of an example of a support link of the device for human upper arm assistance, in accordance with the present disclosure;

FIG. 7 shows a close-up perspective view of an example of an upper end portion of the support link, in accordance with the present disclosure;

FIG. 8 shows a close-up perspective view of an example of a base bracket of the device for human upper arm assistance, in accordance with the present disclosure;

FIG. 9 shows a close-up perspective view of a part of the base bracket of the device for human upper arm assistance, in accordance with the present disclosure;

FIG. 10 shows a close-up perspective view of an example of a torque generator of the device for human upper arm assistance, where a protect shell is hidden, in accordance with the present disclosure;

FIG. 11 schematically shows a control principle of a force generator of a device for human upper arm assistance in accordance with the present disclosure;

FIG. 12 shows a side view of an exemplary device for human upper arm assistance, that is worn by a user, assisting one arm in outstretching, in accordance with the present disclosure;

FIG. 13 shows a back view of an exemplary device for human upper arm assistance, that is worn by a user, assisting two arms in extending horizontally, in accordance with the present disclosure;

FIG. 14 shows a back view of an exemplary device for human upper arm assistance, that is worn by a user, where elastic ropes are attached between a back strap and a torso link, in accordance with the present disclosure;

FIG. 15 shows a perspective view of an example of a torso link of the device for human upper arm assistance, in accordance with the present disclosure;

FIG. 16 shows a perspective view of an example of a shoulder joint hinge of the device for human upper arm assistance, where a hinge protect shell is hidden, in accordance with the present disclosure;

FIG. 17 shows a perspective view of an example of a base bracket of the device for human upper arm assistance, where the torso link, back strap and torque generator are hidden, in accordance with the present disclosure;

FIG. 18 shows a perspective view of an example of a torque generator of the device for human upper arm assistance, where its front shell is hidden, in accordance with the present disclosure; and

FIG. 19 schematically shows a working principle of a torque generator of the device for human upper arm assistance, in accordance with the present disclosure.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

As used herein, the singular forms “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, element components, and/or groups thereof.

As utilized herein, the terms “length”, “width”, “upper”, “lower”, “front”, “rear”, “left”, “right”, “vertical”, “horizontal”, “top”, “bottom”, “inner”, “outer” and other directions or positional relations are based on the positions or positional relations shown in the drawings, and are only for the convenience of describing the embodiments of the present application and simplifying the description, rather than indicating or implying that the device or element referred to must have a specific orientation, be configured and operated in a specific orientation, and therefore cannot be understood as a limitation to the embodiments of the present application.

In the embodiments of the present application, unless otherwise clearly specified and defined, the terms “installed/mounted,” “in contact with,” “connected/coupled,” “fixed,” and other terms should be understood in a broad sense. For example, it may be fixedly or detachably connected or may be integrated; it can be a mechanical connection or an electrical connection; it may be directly connected or indirectly connected through an intermediate medium, and it may be an internal communication of two components or an interaction relationship between the two components. For those of ordinary skill in the art, the specific meanings of the above-mentioned terms in the embodiments of the present application can be understood according to specific conditions.

Various embodiments described herein are directed to a device for human upper arm assistance, which includes a support mechanism, an arm link member, a joint member, and a force generating member. The support mechanism is configured for supporting the device on a torso of the user; The arm link member is connectable to the human upper arm. The joint member is in connection with the arm link member and the support mechanism, when the device is in a use state, the joint member transfers load from the upper arm to the body. The force generating member is arranged on the support mechanism and is configured for providing a resisting torque between the arm link member and support mechanism. The force generating member is mechanically configured to apply a relatively larger resisting torque at a predetermined range of motion of the upper arm and to apply a relatively lesser resisting torque outside the predetermined range.

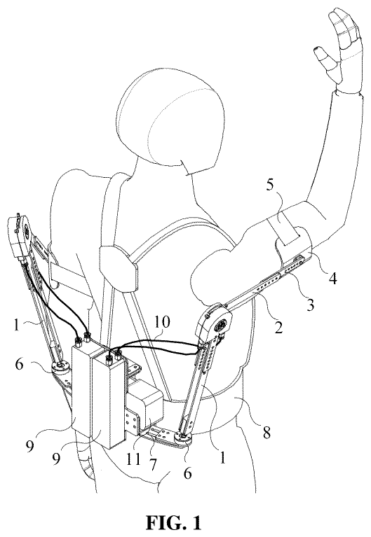

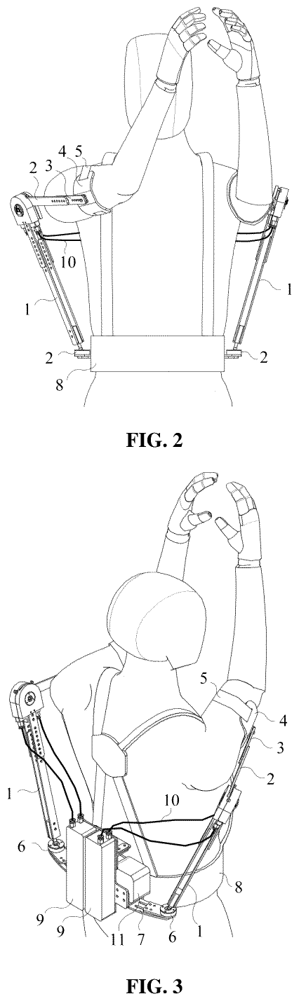

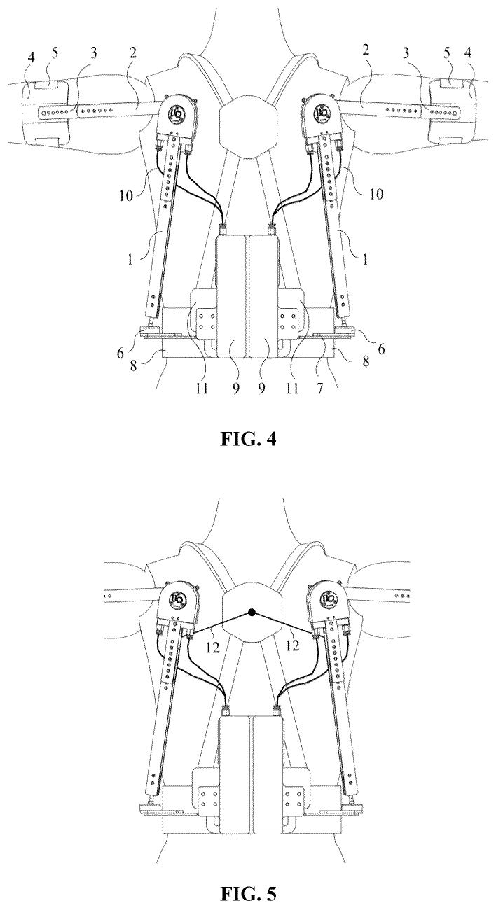

Referring in more detail to the drawings, FIG. 1 shows a perspective view of a human user wearing a device for human upper arm assistance, with user's one arm outstretched. FIG. 2 shows a perspective view of a user wearing the device for human upper arm assistance, with user's two arms outstretched for overhead working. FIG. 3 shows a perspective view of a user wearing the device for human upper arm assistance, with user's two hands reaching same position for overhead operating. FIG. 4 shows a perspective view of a human user wearing a device for human upper arm assistance, with user's two arms extend horizontally. In accordance with an embodiment of the present disclosure, the device for human upper arm assistance may include: a support link 1, a rotate link 2, an arm link 3, an arm connector 4, an arm strap 5, a universal joint 6, a base bracket 7, a back strap 8, a force generator 9, Bowden cables 10 and a control module 11. An upper end portion of the support link 1 is provided with a pulley co-axially supported by the support link 1, and the pulley may further be connected to one end of the rotate link 2. The arm link 3 may be detachably connected to the rotate link 2 and the total length thereof can be adjustable by aligning different hole groups provided thereon. In an exemplary embodiment, one end of the arm link 3 is co-axially connected to the arm connector 4, thus the arm link 3 and the arm connector 4 can rotate relative to each other. The arm connector 4 may be attached to the human upper arm by the arm strap 5. In an embodiment, a lower end of the support link 1 is connected to the universal joint 6, and the universal joint 6, allowing freedom of movement in all directions, may be fixed on the base bracket 7. The base bracket 7, whose length and width are adjustable, is attached to the user by the back strap 8. The force generator 9 is configured to drive the pulley disposed on the support link 1 by the Bowden cables 10. When the force generator 9 pulls the Bowden cables 10, the pulley then rotates the rotate link 2 and provides an assist torque to a shoulder joint for lifting or supporting the arm. In some embodiments, the control module 11 is coupled to the force generator 9, which includes a battery and a controller, where the battery is configured to supply energy to the device, and the controller is configured to control a pulling force of the force generator 9. In some embodiments, the device for human upper arm assistance may be a portable device, wearable by a user. It should be noted that the singular forms “a”, “an” and “the” used in the embodiments include the plural forms as well. In an exemplary configuration, the device for human upper arm assistance includes, among others, one pulley, one support link 1, one rotate link 2, one arm link 3, one arm connector 4, one arm strap 5, and one universal joint 6 to assist the right or left arm movements. In another exemplary configuration, the device for human upper arm assistance includes two support links 1, two rotate links 2, two arm links 3, two arm connectors 4, two arm straps 5, and two universal joints 6 that are directly or indirectly coupled to the base bracket 7 at its left or right side, where each support link is provided with a pulley on its upper end portion, where the control module 11 and the force generator 9 are both disposed on the base bracket 7, and where the force generator 9 is configured to drive the left and/or right pulleys through Bowden cables 10 to assist the right/left arm movements or both arms movements. In some embodiments, the device may be mounted on the back of the user, providing assist for supporting the arm and reducing the muscle fatigue of the shoulder joint.

In the embodiments, the device can match the degree of freedom of the shoulder joint and adapt to different arm movements including the arm lifting up, naturally dropping, wide horizontal outstretching, overhead working, overhead operating with two hands reaching same position and so on, as illustrated in FIGS. 1-4. In some embodiments, elastic ropes 12 may further be provided to connect the back strap 8 and the support link 1, as shown in FIG. 5, ensuring the support link 1 move in an expected range.

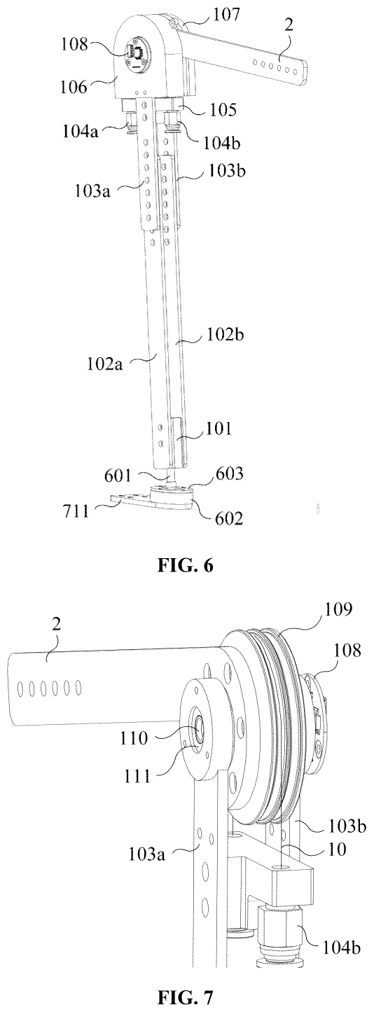

Referring to FIGS. 6-10, main portions of the device for human upper arm assistance are illustrated. In FIG. 6, it is shown a close-up perspective view of the support link according to an embodiment of the present disclosure. In an exemplary embodiment, the support link 1 includes a support block 101, two lower plates 102a and 102b, two upper plates 103a and 103b, two cable sheath connectors 104a and 104b and an upper support block 105. The universal joint 6 includes a universal bearing 601, a bearing seat 602 and a bearing end cap 603. The universal bearing 601 is fixed by the bearing seat 602 and the bearing end cap 603. The lower end of the support link 1 is connected to the universal bearing 601. The bearing seat 602 is installed on a bearing support plate 711 of the base bracket 7. In this embodiment, the lower end of the support link is coupled to the base bracket through a universal bearing which makes the device flexible enough to follow most movements of the arm and allow the pulley 109 align the axis of the shoulder joint of the user. In some embodiments, the two lower plates 102a and 102b are fixed on the support block 101 and detachably connected to the two upper plates 103a and 103b, respectively. The total length of the two lower plates 102a and 102b and the two upper plates 103a and 103b is adjustable by aligning different hole groups provided thereon. The two cable sheath connectors 104a and 104b fixed on the upper support block 105 are configured to connect the upper plates 103a and 103b, respectively. In some embodiments, the pulley 109 covered by a left-side shell 106 and a right-side shell 107 is supported by the upper plates 103a and 103b of the support link 1 via a shaft 110 and bearings 111, as shown in FIG. 7. In the embodiments, the pulley 109 may be fixed to the rotate link 2 by screws, and the Bowden cables 10 may be connected to the pulley 109 by stocking one of the Bowden cables in a small hole. In some embodiments, an angle encoder 108 may be attached to one end of the shaft 110.

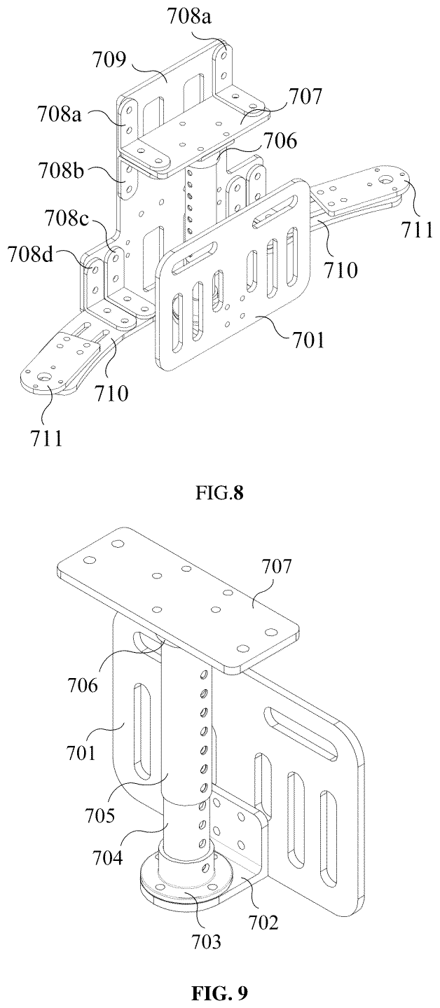

Working in conjunction with the support link 1 is the rotate link 2 and the base bracket 7. The rotate link 2 is coupled to the pulley 109 supported by the support link 1. The lower end of the support link 1 is coupled to the base bracket 7 through the universal joint 6 as illustrated in the above embodiments. Referring to FIGS. 8 and 9, the base bracket 7 may include a back plate 701, a bottom connector 702, a lower tube support 703, a lower tube 704, an upper tube 705, an upper tube support 706, L-connectors 708a, 708b, 708c and 708d, a main support plate 709, a curved plate 710 and a bearing support plate 711. In an exemplary embodiment, the back plate 701 is attached to the back strap 8. The lower tube support 703 is fixed to the back plate 701 via the bottom connector 702, as shown in FIG. 9. The lower tube 704 is installed on the lower tube support 703 and connected to the upper tube 705, which is further configured to support the upper plate 707 via the upper tube support 706. The main support plate 709 is fixed to the upper plate 707 by the L-connectors 708a and 708b and the force generator 9 may be installed on the main support plate 709. The curved plate 710 is installed to the main support plate 709 by the L-connectors 708c and 708d. The curved plate 710 may be connected to the bearing support plate 711 by screws.

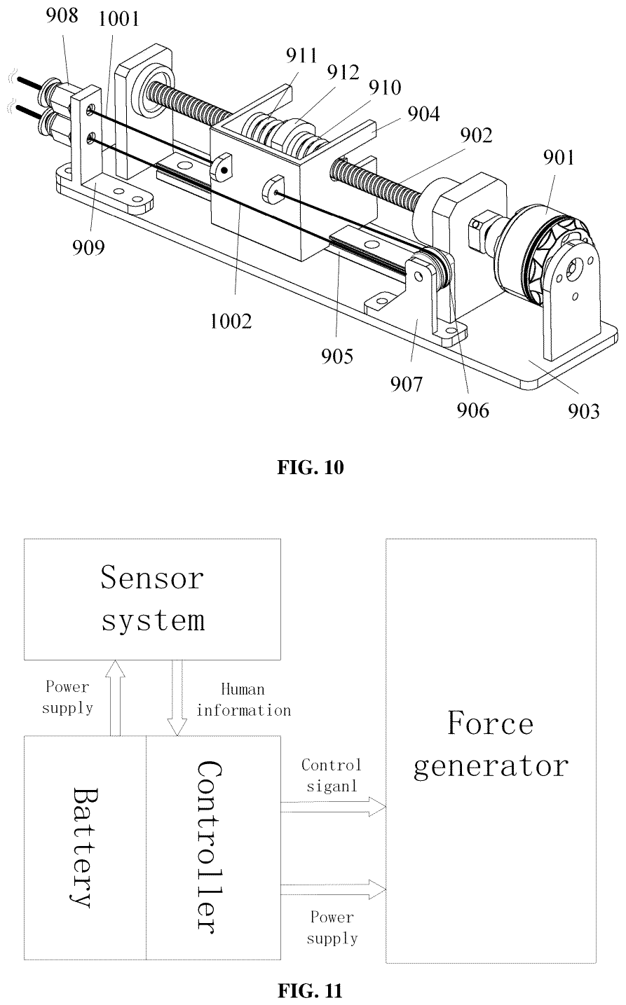

Referring to FIG. 10, it is shown a close-up view of a preferred embodiment of the torque generator in accordance with the present disclosure, where a protect shell is hidden. In this embodiment, the force generator 9 may include an electric motor 901, a ball screw 902, a base plate 903, a slider 904, a slide rail 905, a roller 906, a roller base 907, two cable connectors 908, an L-shape base 909, two springs 910 and 911, and a sliding part 912. The electric motor 901 and the ball screw 902 are fixed on the base plate 903 as the prime mover. The slider 904 is installed on the slide rail 905 and can move along with it. One end of the outgoing Bowden cable 1001 is fixed on the slider 904 and the other end is connected to the pulley 109. One end of the returning Bowden cable 1002 is also fixed on the slider 904 and the other end is connected to the pulley 109. The roller 906 is fixed on the roller base 907 to guide the direction of the returning Bowden cable 1002. The two cable connectors 908 are fixed on the L-shape base 909 for cable connection. The two springs 910 and 911 are disposed between the sliding part 912 of the ball screw 902 and the slider 904. In operation, the force generator pulls the Bowden cables and makes the pulley 109 to drive the rotate rod, thus generates an assist torque at a shoulder joint of the user and helps the user support the arm, the force on the Bowden cables can be ensured by controlling the deformation of the springs 910 and 911.

Referring now to FIG. 11, it is schematically illustrated a control principle of the force generator in accordance with the present disclosure. In an exemplary embodiment, the control module 11 includes a battery and a controller. The battery is configured to supply energy to a sensor system and the force generator 9. The sensor system is configured to detect information of a user and further provide the detected information to the controller. The controller is configured to generate and provide a control signal to the force generator 9 based on the information of the user detected by the sensor system. The sensor system may be provided with one or more sensors integrated into the device. The one or more sensors may include an angle sensor (e.g., rotary encoder 108), a velocity sensor, an accelerometer or a force sensor and the like. The controller may also have a user input interface through which the user can chose a working or non-working mode. In the working mode, the force generator 9 is configured to pull the cables 10 and provide an assist torque to a shoulder joint of the user. In the non-working mode, the force generator 9 is configured to let the Bowden cables 10 follow the motion of the arms and thus the arms move freely with little constraint. The force generator 9 may include a hydraulic cylinder, an electric motor, a pneumatic system or any other actuator, as long as it can pull the Bowden cables 10 and drive the pulley 109. In an exemplary embodiment, the one or more sensors communicating with the force generator to toggle the force generator between the working mode and the non-working mode though some residual, though minimal, resisting torque may be present from the need to move components of the force generator relative to each other.

The device disclosed herein may be used to assist the left/right arm or both arms, depending on an actual physical task that involves a complex movement of one or both of the human arms relative to the body. The support link is installed on the base bracket through the universal joint which makes the device flexible enough to follow most movements of the arm and allow the pulley align the axis of the shoulder joint of the user. The base bracket is coupled to the back of the user at a waist position by the back strap thereby supporting the device on the torso of the user. The pulley that is provided on the upper end portion of the support link is co-axially supported by the support link, the rotate link whose one end is coupled to the pulley and the other coupled to the upper arm of the user and moves synchronously with the arm, and the force generator is fixed on the base bracket at the waist position and configured to drive the pulley via Bowden cables during operation, such as a user lifts or hold the arm at a certain angle. Such that the force generator can pull the Bowden cables and make the pulley to drive the rotate rod, thus generate an assist torque at the shoulder joint and help the user support the arm.

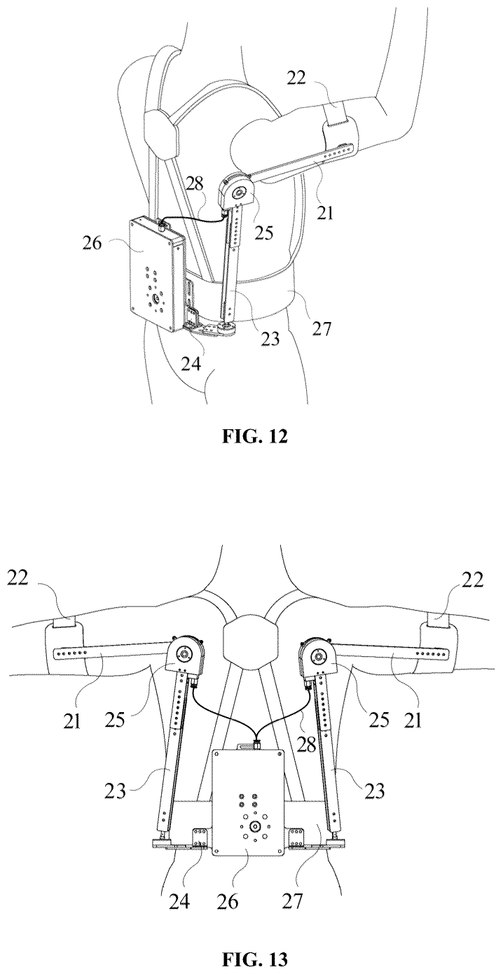

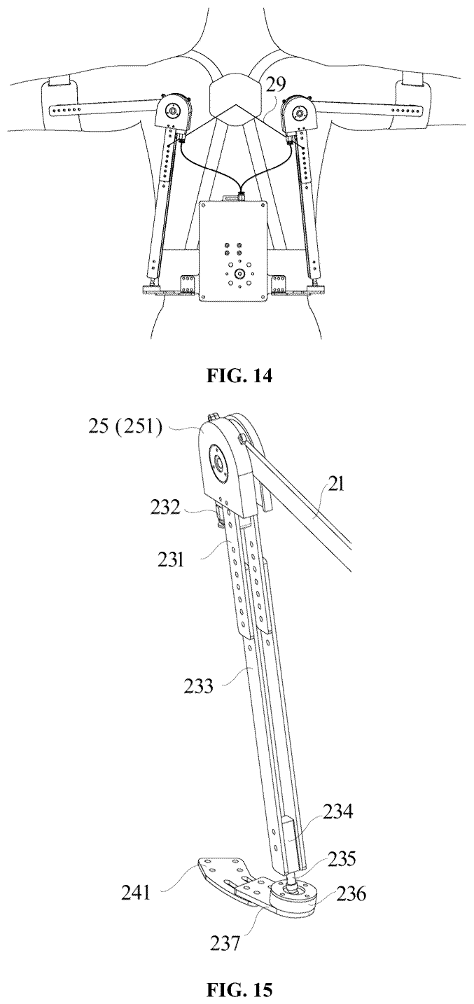

Turning to FIGS. 12-19, another example device for human upper arm assistance is illustrated, which provides torque between the upper arm and the torso to reduce the muscle fatigue of the shoulder joint of the user. The device may include an arm link 21, a torso link 23, a base bracket 24, a shoulder joint hinge 25, a torque generator 26, a back strap 27 and Bowden cables 28 to assist the right or left arm movements or both arms movements. The arm link 21 may be coupled to an upper arm of the user by the arm strap 22. The torso link 23 may be fixed on the base bracket 24. The shoulder joint hinge 25 is rotatably coupled between the arm link 21 and the torso link 23 is arranged parallel to a shoulder joint of a user when the device is in a mounted state. Inside the shoulder joint hinge 25, a pulley 252 is provided. The torque generator 26 may be fixed on the base bracket 24. The base bracket may be coupled to the torso of the user by the back strap 27. The torque generator 6 is configured to drive a pulley 252 inside the shoulder joint hinge 25 through Bowden cables 28. In operation, the torque generator 26 provides a resisting torque between the arm link 21 and the torso link 23. Thus, the arm link 21 imposes an upward pulling force on the upper arm and reduces the moment burden of the user's shoulder joint. The torque generator 26 is configured to provide largest assist torque when arm is raised perpendicular to the torso, but give nearly zero torque when arm is near a natural drooping position. The user will be well assisted when lifting the arm for overhead work, but will feel comfortable when resting the arm or performing other daily activities. It should be noted that the singular forms “a”, “an” and “the” used in the above embodiments include the plural forms as well. In an exemplary configuration, as shown in FIG. 12, an example device for human upper arm assistance, assisting one arm in outstretching in accordance with the present disclosure is provided. In this configuration, the device includes, among others, one arm link 21, one torso link 23, one shoulder joint hinge 25 to assist the right or left arm movements. In another exemplary configuration, as illustrated in FIGS. 13 and 14, the device for human upper arm assistance is used to assist two arms in extending horizontally. The device includes two arm links 21, two torso links 23 and two shoulder joint hinges 25 to assist both arms. Two torque generators 26 may be provided on the base bracket 24 to respectively drive the left and right shoulder joint hinges 25 through Bowden cables 28. It can be anticipated that the device in this configuration can also be used to assist the left or right movements. In some embodiments, elastic ropes 29 may be attached between the back strap 27 and the torso link 23, as shown in FIG. 14, ensuring the torso links 3 move in the expected range.

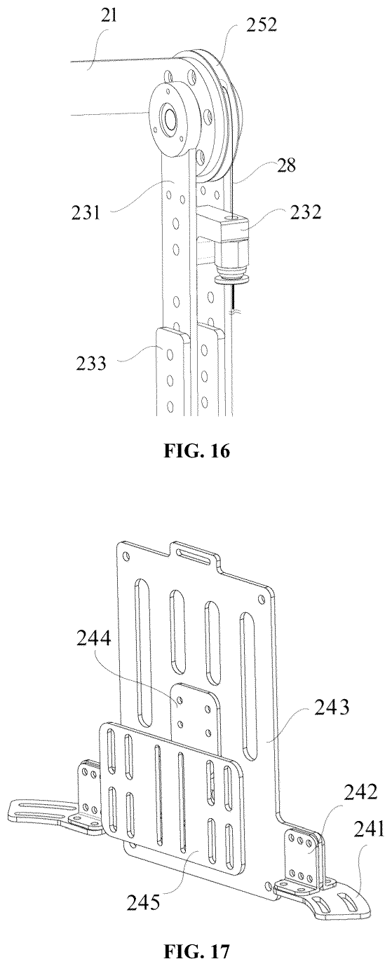

Referring to FIG. 15, it is shown a perspective view of a torso link of the device for human upper arm assistance in accordance with an embodiment of the present disclosure. The torso link 23 may include two upper support links 231, a cable connector 232, two lower support links 233, a lower connector 234, a universal bearing 235, a bearing base 236, and a lower plate 237. The two upper support links 231 may be rotatably coupled with the shoulder joint hinge 25. The cable connector 232 may be fixed on the upper support link 231 to connect the Bowden cables 28. The two lower support links 233 may be operably connected to the upper support links 231 and their relative position can be adjusted to adapt to different height requirements. The lower connector 234 may be coupled with the lower support links 233 and the universal bearing 235. The bearing base 236 is configured to support the universal bearing 235 and is fixed on the lower plate 237. The lower plate 237 is connected to a curved plate 241 of the base bracket 24. The relative position of the lower plate 237 and the curved plate 241 is adjustable to adapt to different width requirements. The shoulder joint hinge 25 may be covered by a hinge protect shell 251. As described in more detail in FIG. 16, a perspective view of the shoulder joint hinge in accordance with an embodiment of the present disclosure is shown, where a hinge protect shell is hidden. The shoulder joint hinge 25 mainly includes a pulley 252 that is fixed to the arm link 21 and rotatably coupled with the upper support links 231 of the torso link 23 via shaft and bearings. One end of the Bowden cables 28 may be stuck in a small hole on the pulley 252 and the other end may be connected to the torque generator 26.

Referring to FIG. 17 it is shown a perspective view of a base bracket of the device in accordance with an embodiment of the present disclosure, where the torque generator, torso link and back strap are hidden. The base bracket 24 may include one or two curved plates 241, two L-shape connectors 242, a mounting plate 243, a S-shape connector 244 and a back plate 245. The one or two curved plates 241 is configured to connect one or two torso links 23. The curved plate 241 may be fixed to the mounting plate 243 by the two L-shape connectors 242. In some embodiments, the relative position of the mounting plate 243 and the curved plate 241 is adjustable to adapt to different width requirements. The torque generator 6 may also be installed on the mounting plate 243. The S-shape connector 244 is configured to connect the mounting plate 243 and the back plate 245 which is attached to the back strap 27 and worn by the user.

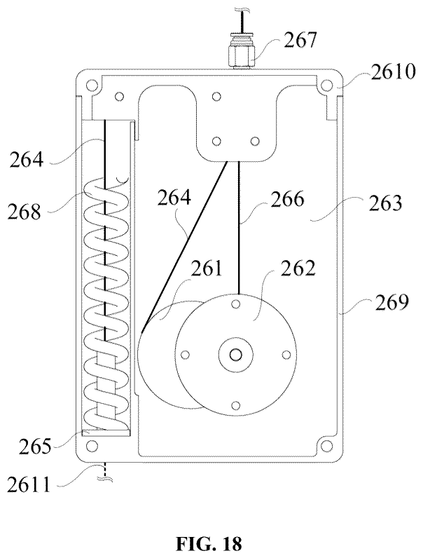

Referring to FIG. 18, it is shown a perspective view of a torque generator in accordance with an embodiment of the present disclosure, where its front shell is hidden. The torque generator 26 includes: an eccentric pulley 261, a pulley support 262, front shell, the back shell 263, Bowden cables 264 and 266, cable connector 267, a compression spring 268, a lower shell 269, an upper shell 2610 and rollers 2611. The eccentric pulley 261 is rotatably coupled with the pulley support 262 via shaft and bearings. The pulley support 262 is fixed on the front shell and the back shell 263. One end of the Bowden cable 264 is stuck in a small hole of the eccentric pulley 261 and the other end is fixed to the end cap 265. One end of the Bowden cable 266 is also stuck in the small hole of the eccentric pulley 261 but is not connected with the Bowden cable 264. The other end of the Bowden cable 266, via the cable connector 267, is connected to the pulley 252 of the shoulder joint hinge 25. The end cap 265 is configured to compress the compression spring 268 and its cylinder structure can guide a motion of the compression spring 268. The end cap 265 and the compression spring 268 can slid along a cavity of the lower shell 269. The Bowden cables 264 and 266 are guided by the rollers 2611 which are integrated in the upper shell 2610. In some embodiments, an elastic rope may be provided with its one end being connected to the Bowden cable 264 and its other end being connected to some fixed point on device, so as to tension the cable.

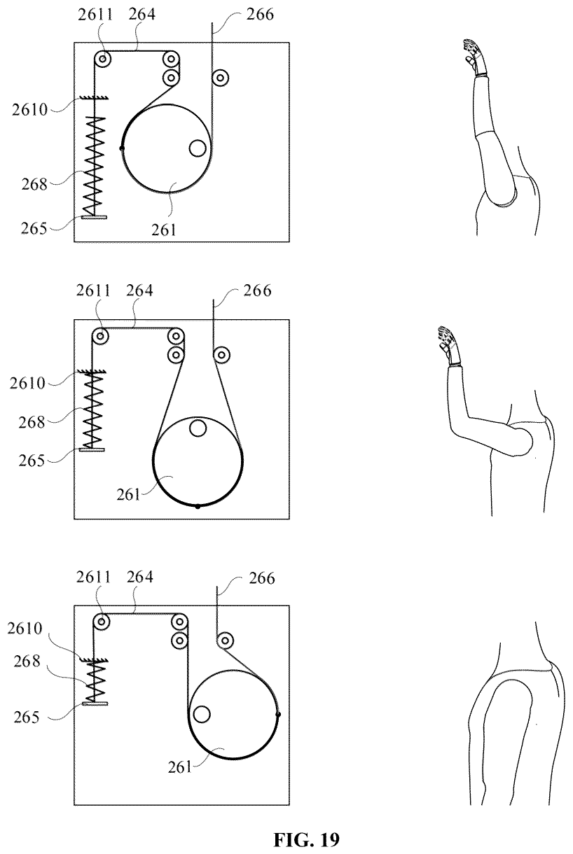

Referring now to FIG. 19, it is schematically illustrated the working principle of the torque generator of the device for human upper arm assistance in accordance with an embodiment of the present disclosure. When the user's arm is raised almost parallel to the torso, the moment arm of the Bowden cable 266 is much smaller than that of the Bowden cable 264. However, the compression spring 268 is not compressed in this situation, the force of the Bowden cable 264 is substantially equaled to a pretension force which is very small, thereby an assist torque of the device will be small. When the user's arm is near the position perpendicular to the torso, the moment arms of the Bowden cables 264 and 266 are almost equal, therefore the force of the Bowden cable 266 is close to the compression force of the compression spring 268 and a large assist torque can be provided for assisting the shoulder joint of the user. When the user's arm is put down, near a natural drooping position, the compression spring 268 will be fully compressed. However, the moment arm of the Bowden cable 266 is much larger than that of the Bowden cable 264, therefore the force of the Bowden cable 266 is nearly zero and the user will feel free to move the arm.

In the embodiments, the device can be used to assist the left/right arm movements or both arms movements. The arm link is coupled with the user's upper arm by arm straps, The torque generator and the torso link is fixed on the base bracket that can be coupled to the user's waist by the back strap. The torso link is coupled to the base bracket through a universal bearing which makes the device flexible enough to follow most movements of the arm and allow the pulley inside the shoulder joint hinge align the axis of the shoulder joint of the user. The shoulder joint hinge is placed parallel to the user's shoulder joint when the device is in a mounted state, rotatably coupling the arm link and the torso link. The torque generator drives the pulley inside the shoulder joint hinge through Bowden cables. In operation, the torque generator provides a resisting torque between the arm link and the torso link. The eccentric pulley moves, in use, with the upper arm, the eccentricity of the eccentric pulley defines a predetermined range where a relatively larger resisting torque is applied. Thus, the arm link imposes an upward pulling force on the upper arm and reduces the moment burden of the shoulder joint. The torque generator provides largest assist torque when arm is raised perpendicular to the torso, but gives nearly zero torque when arm is near the natural drooping position. The user will be well assisted when lifting the arm for overhead works, and also feel comfortable when resting the arm or performing other daily activities.

Various embodiments of the present disclosure are directed to devices for human upper arm assistance, in which, Bowden cables are used to transmit force to the shoulder joint. The force/torque generator, which may be force controllable actuators, is placed at human's back position and does not move with the arms. The structure at human's shoulder position is small and lightweight, containing only a pulley and thin shells installed on the support link member. When a user needs assist, the force generators pull the Bowden cables and drives the pulley to rotate an arm link member that attached to human's arm, generating a torque to the shoulder joint and reducing the muscle fatigue. Therefore, the structure near the shoulder joint can be small and lightweight and the energy loss for moving the torque generator with the arm can be avoided. In addition, the torque generator of the device provides largest assist torque when the arm is raised perpendicular to the torso, but gives nearly zero torque when arm is near the natural drooping position, thereby let the user feel free in daily activities.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples). It should also be noted that the terms “approximately” and “substantially,” as used herein are intended to have a broad meaning in harmony with the common and accepted usage by those of ordinary skill in the art to which the subject matter of this disclosure pertains.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1-31. (canceled)

32. A device for assisting an upper arm of a user, comprising:
a support mechanism configured for supporting the device on a torso of the user;
an arm link member connectable to the upper arm;
a joint member coupled with the arm link member and the support mechanism, wherein the device, in use, transfers a load from the upper arm, through the joint member to the torso; and
a force generating member arranged on the support mechanism and configured for providing a resisting torque between the arm link member and support mechanism, and wherein the force generating member is mechanically configured to apply a relatively larger resisting torque at a predetermined range of motion of the upper arm and to apply a relatively lesser resisting torque outside the predetermined range.

33. The device according to claim 32, wherein the predetermined range of the motion of the upper arm comprises a case where the upper arm is perpendicular to the torso and the force generating member is configured to provide largest resisting torque when the upper arm is raised perpendicular to the torso.

34. The device according to claim 32, wherein the force generating member is configured to apply substantially no force when the upper arm is in a natural drooping position.

35. The device according to claim 32, wherein the joint member is rotatably coupled to the arm link member and the support mechanism, and is arranged parallel to a shoulder joint of the user when the device is in a mounted state.

36. The device according to claim 32, wherein the force generating member is a torque generator, the torque generator comprises an eccentric pulley, wherein the eccentric pulley moves, in use, with the upper arm, and an eccentricity of the eccentric pulley defines the predetermined range, and wherein the force generating member comprises:
one or more springs for controlling a magnitude of the resisting torque;
a sensor system configured to detect information of the user; and
a control module configured to generate and provide a control signal to the force generating member based on the information of the user detected by the sensor system.

37. The device according to claim 32, wherein the force generating member is configured to apply the resisting torque at the joint member using one or more Bowden cables.

38. The device according to claim 32, wherein the support mechanism is mounted on a back of the user by a back strap, and wherein elastic ropes are provided connecting the back strap and the support mechanism.

39. A device for assisting at least one upper arm of a user, comprising:
a support mechanism configured for supporting the device on a torso of the user, and comprising:
a base bracket; and
two support link members coupled to the base bracket, respectively; and
two arm link members connectable to the upper arm;
two joint members coupled with the two arm link members and the two support link members, respectively, wherein the device, in use, transfers a load from the upper arm, through the two joint members to the torso; and
at least one force generating member arranged on the base bracket and configured for providing a resisting torque between each arm link member and the support mechanism, wherein the at least one force generating member is mechanically configured to apply a relatively larger resisting torque at a predetermined range of motion of the upper arm and to apply a relatively lesser resisting torque outside the predetermined range.

40. The device according to claim 39, wherein the predetermined range of the motion of the upper arm comprises a case where the upper arm is perpendicular to the torso and the at least one force generating member is configured to provide largest resisting torque when the upper arm is raised perpendicular to the torso.

41. The device according to claim 39, wherein the at least one force generating member is configured to apply substantially no force when the upper arm is in a natural drooping position.

42. The device according to claim 39, wherein the joint member is rotatably coupled to the arm link member and the support mechanism, and is arranged parallel to a shoulder joint of the user when the device is in a mounted state.

43. The device according to claim 39, wherein each of the at least one force generating member is a torque generator, the torque generator comprises an eccentric pulley, wherein the eccentric pulley moves, in use, with the upper arm, and an eccentricity of the eccentric pulley defines the predetermined range, and wherein each of the at least one force generating member comprises:
one or more springs for controlling a magnitude of the resisting torque;
a sensor system configured to detect information of the user; and
a control module configured to generate and provide a control signal to the at least one force generating member based on the information of the user detected by the sensor system.

44. The device according to claim 39, wherein each of the at least one force generating member is a force generator, and wherein the force generator comprises a hydraulic cylinder, an electric motor or a pneumatic system for generating the resisting torque.

45. The device according to claim 39, wherein the at least one force generating member is configured to apply the resisting torque at the joint member using one or more Bowden cables.

46. The device according to claim 43, wherein the sensor system comprises one or more of an angle sensor, a velocity sensor, a force sensor and an accelerometer.

47. The device according to claim 39, wherein the support mechanism is configured to support the device through the base bracket, and the base bracket is attached to a back of the user by a back strap during operation.

48. The device according to claim 39, wherein each support link member is coupled to the base bracket through a universal bearing.

49. The device according to claim 39, wherein a length of each support link member is adjustable and/or a length of each arm link member is adjustable.

50. The device according to claim 39, wherein the device further comprises elastic ropes connected between the back strap and the two support link members.

51. A device for assisting at least one upper arm of a user, comprising:
at least one arm link member connectable to the upper arm of the user;
a base bracket attachable to a torso of the user;
at least one support link member coupled to the base bracket;
at least one joint member rotatably coupled with the at least one arm link member and the at least one support link member, respectively, wherein the device, in use, transfers load from the upper arm, through the at least one joint member to the torso of the user; and
at least one force generating member arranged on the base bracket and configured to provide a resisting torque between the at least one arm link member and the at least one support link member, respectively, wherein the at least one force generating member is mechanically configured to apply a relatively larger resisting torque at a predetermined range of motion of the upper arm and to apply a relatively lesser resisting torque outside the predetermined range, and wherein the at least one force generating member is configured to provide largest resisting torque when the upper arm is raised perpendicular to the torso, and provide substantially no torque when the upper arm is in a natural drooping position.
